(19) United States
(12) Patent Application Publication
(10) Pub. No.: US 2021/0155074 A1
(43) Pub. Date: May 27, 2021

(54) PACKAGE OF VEHICLE HEAT EXCHANGER MODULES WITH CONTROLLED COVERS

(71) Applicant: GM Global Technology Operations LLC, Detroit, MI (US)

(72) Inventors: Srinivasa Rao Vaddiraju, Troy, MI (US); Christopher M. Frizza, Beverly Hills, MI (US); Todd C. Marhenke, Auburn Hills, MI (US)

(21) Appl. No.: 16/692,605

(22) Filed: Nov. 22, 2019

(51) Int. Cl. B60H 1/00

(52) U.S. Cl. CPC B60H 1/00842; B60H 2001/00099; B60H 2001/00107; B60H 1/00864

(57) ABSTRACT

Methods and systems to dissipate heat in a vehicle include a first condenser portion, and a second condenser portion arranged parallel with the first condenser portion. The system includes a fan arranged parallel with the first condenser portion and the second condenser portion. The fan draws air flow from the first condenser portion and the second condenser portion. The system also includes a radiator arranged substantially perpendicular with the first condenser portion and the second condenser portion, and one or more covers controlled to an open or closed position. A controller controls the position of the one or more controlled covers.

### INTRODUCTION

The subject disclosure relates to a package of vehicle heat exchanger modules with controlled covers.

A vehicle (e.g., automobile, motorcycle, truck, construction equipment, farm equipment, automated factory equipment) includes many components that must be accommodated in a limited amount of space. Some of the components of the vehicle generate heat that, in turn, requires additional components to dissipate and vent that heat. Accordingly, it is desirable to provide a package of vehicle heat exchanger modules with controlled covers.

### SUMMARY

In one exemplary embodiment, a system to dissipate heat in a vehicle includes a first condenser portion, and a second condenser portion arranged parallel with the first condenser portion. A fan is arranged parallel with the first condenser portion and the second condenser portion. The fan draws air flow from the first condenser portion and the second condenser portion. The system also includes a radiator arranged substantially perpendicular with the first condenser portion and the second condenser portion, and one or more covers to be controlled to an open or closed position to affect dissipation of the heat from the first condenser portion, the second condenser portion, or the radiator. A controller controls the position of the one or more controlled covers.

In addition to one or more of the features described herein, the one or more covers include a deflector.

In addition to one or more of the features described herein, the deflector forms an air dam below the vehicle in the open position.

In addition to one or more of the features described herein, the one or more covers include a set of flaps adjacent to the deflector.

In addition to one or more of the features described herein, the set of flaps facilitate air flow through the radiator and out of the vehicle in the open position.

In addition to one or more of the features described herein, the one or more covers include a baffle.

In addition to one or more of the features described herein, the baffle blocks one end of a gap between the fan and a closest one among the first condenser portion and the second condenser portion in the closed position.

In addition to one or more of the features described herein, the baffle facilitates air flow through the radiator to the fan via the one end of the gap in the open position.

In addition to one or more of the features described herein, the controller controls the position of the one or more covers based on inputs.

In addition to one or more of the features described herein, the inputs include temperature, battery charging status, or a speed of the vehicle.

In another exemplary embodiment, a method of configuring a heat dissipation system in a vehicle includes arranging a first condenser portion and a second condenser portion in parallel with each other. The method also includes disposing a fan in parallel with the first condenser portion and the second condenser portion. The fan draws air flow from the first condenser portion and the second condenser portion. A radiator is arranged to be substantially perpendicular with the first condenser portion and the second condenser portion. One or more covers is controlled to an open or closed position to affect dissipation of the heat from the first condenser portion, the second condenser portion, or the radiator, and a controller controls the position of the one or more covers.

In addition to one or more of the features described herein, the arranging the one or more covers includes arranging a deflector at a perimeter of the vehicle.

In addition to one or more of the features described herein, controlling the deflector to be in the open position forms an air dam below the vehicle based on a location of the deflector at the perimeter of the vehicle.

In addition to one or more of the features described herein, the arranging the one or more covers includes arranging a set of flaps to be adjacent to the deflector at the perimeter of the vehicle.

In addition to one or more of the features described herein, controlling the set of flaps to be in the open position facilitates air flow through the radiator and out of the vehicle.

In addition to one or more of the features described herein, the configuring the controller to control the position of the one or more covers includes configuring the controller to control the set of flaps and the deflector to be in the open position together.

In addition to one or more of the features described herein, the arranging the one or more covers includes arranging a baffle to block one end of a gap between the fan and a closest one among the first condenser portion and the second condenser portion in the closed position.

In addition to one or more of the features described herein, controlling the baffle to be in the open position facilitates air flow through the radiator to the fan via the one end of the gap in an open position.

In addition to one or more of the features described herein, the controller receiving inputs, wherein the inputs include temperature, battery charging status, or a speed of the vehicle.

In addition to one or more of the features described herein, the controller identifying a scenario based on the inputs and controlling the position of the one or more covers according to the scenario.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that includes a package of vehicle heat exchanger modules with controlled covers according to one or more embodiments;

FIG. 2 details aspects of the package of vehicle heat exchanger modules with controlled covers according to one or more embodiments;

FIG. 3 details aspects of the package of vehicle heat exchanger modules with controlled covers according to one or more embodiments; and

FIG. 4 is a process flow of a method of controlling covers of the package of vehicle heat exchanger modules with controlled covers according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a vehicle has a limited amount of space for all of the components that it comprises. Certain designs impose even greater restrictions on the size and arrangement of components than others. Embodiments of the systems and methods detailed herein relate to a package of vehicle heat exchanger modules with controlled covers. An exemplary vehicle design used herein for explanatory purposes is an electric vehicle that facilitates a front-end storage space and/or a low front hood. In addition, the batteries are stored below the center portion of the vehicle, for example. The heat exchanger modules of the vehicle are referred to as the condenser radiator fan modules (CRFM) and represent a heat dissipation system. Thus, the package of vehicle heat exchanger modules with controlled covers according to one or more embodiments is interchangeably referred to herein as the CRFM package. The CRFM package must fit in a height-limited space below the storage space.

To address the height limitation, the CRFM includes a split condenser (i.e., two condenser portions) to cool the cabin and the batteries, and a laydown low temperature radiator (LTR) to cool power electronics. The laydown LTR is a horizontally disposed radiator that requires vertical airflow rather than a traditional vertical radiator with horizontal airflow through it. According to one or more embodiments detailed herein, the CRFM package includes different types of covers that are controlled based on temperature and vehicle speed. As detailed, these covers facilitate sufficient airflow through the LTR, which is part of the CRFM, at all speeds of the vehicle.

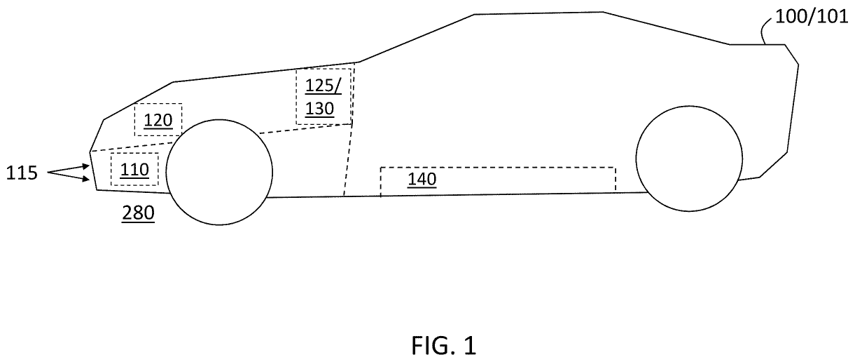

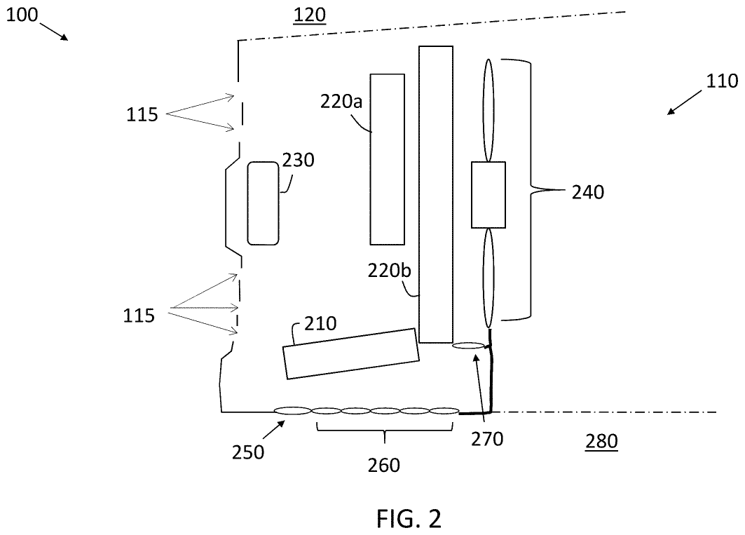

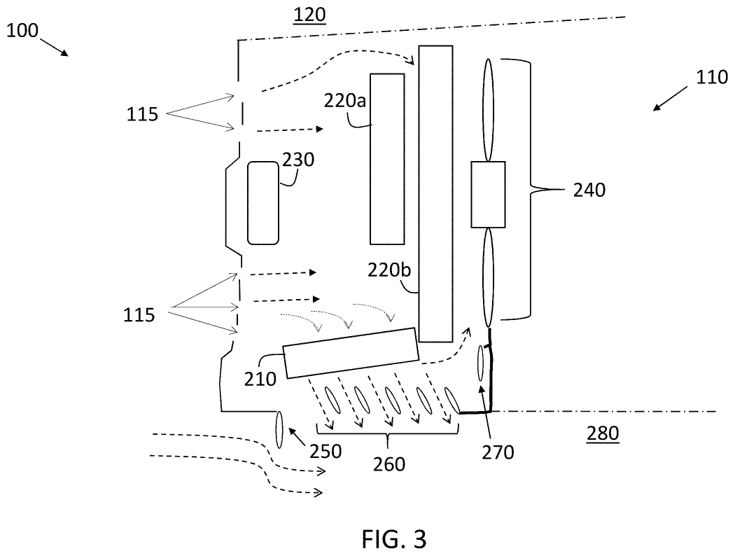

In accordance with an exemplary embodiment, FIG. 1 is a block diagram of a vehicle 100 that includes a package of vehicle heat exchanger modules with controlled covers (i.e., a CRFM package 110). The exemplary vehicle 100 in FIG. 1 is an automobile 101. The CRFM package 110 is shown below a storage space 120 in the front portion of the vehicle 100. The outside 280 under the vehicle 100 is indicated and further referenced in the discussion of FIGS. 2 and 3. The CRFM package 110 and air vents 115 (e.g., grill of the vehicle 100) indicated in FIG. 1 are further detailed in FIGS. 2 and 3. A controller 125 and other vehicle systems 130 are shown at the rear of the storage space 120, and batteries 140 are shown below a passenger compartment of the vehicle 100. The location of the components is not limited by the exemplary arrangement shown in FIG. 1.

The controller 125 may control the covers that are part of the CRFM package 110, as discussed with reference to FIGS. 2 and 3. The control may be based on information from the other vehicle systems 130. This information may include power electronics loop and drive unit temperatures and the speed of the vehicle 100. The controller 125 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 details aspects of the package of vehicle heat exchanger modules with controlled covers (i.e., the CRFM package 110) according to one or more embodiments. The storage area 120 above the CRFM package 110 and the outside 280 of the vehicle 100 that is below the vehicle 100 are indicated. As previously noted, the CRFM package 110 includes a laydown LTR 210 and a split condenser in the form of a first condenser portion 220a and a second condenser portion 220b (generally referred to as 220). The first condenser portion 220a may have a height, according to the orientation shown in FIG. 2, that is half that of the condenser portion 220b. For example, the condenser portion 220a may be on the order of 250 millimeters (mm) high while the condenser portion 220b may be on the order of 500 mm high. Alternately, both condenser portions 220a, 220b may have the same height. The core width of both condenser portions 220a, 220b may be on the order of 500 mm, for example. The LTR 210 may have a width according to the orientation shown in FIG. 2 that is comparable to the height of the condenser portion 220a (e.g., 250 mm).

A bumper beam 230 and a fan 240 to vent hot air away from the condenser portions 220 is also shown. The fan 240 is disposed in series with the condenser portions 220 with a gap between the fan 240 and the second condenser portion 220b, as shown. That is, the fan 240 is parallel to the condenser portions 220, as shown in FIG. 2, while the LTR 210 is perpendicular to the condenser portions 220 and to the fan 240. The hot air may eventually exit the vehicle 100 via side vents (i.e., port holes) or vents in the hood, for example. Three types of controlled covers are shown in FIG. 2, a deflector 250, flaps 260, and a baffle 270. Each type serves a different function, as further discussed with reference to FIG. 3. All of the covers are shown in the closed position in FIG. 2. As shown, the deflector 250 and the flaps 260 are at the perimeter of the CRFM package 110 bordering the outside 280 below the vehicle 100. The baffle 270 is inside the CRFM package 110.

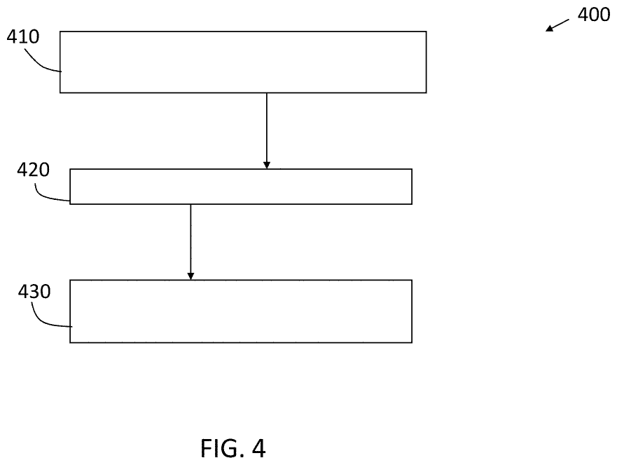

FIG. 3 details aspects of the package of vehicle heat exchanger modules with controlled covers (i.e., the CRFM package 110) according to one or more embodiments. In FIG. 3, the deflector 250, the flaps 260, and the baffle 270 are all shown in the open position for explanatory purposes. However, all three covers are not controlled to be open under normal circumstances, as discussed with reference to FIG. 4. Air flow is indicated with dashed lines. When the deflector 250 is in the open position, it extends below the vehicle 100 to the outside 280, as indicated. This creates an air dam directly below the vehicle 100 that causes air flow under the vehicle 100 to accelerate. The resulting vacuum that is created under the vehicle 100 pulls air down through the LTR 210. Air through the LTR 210 exits the vehicle 100 via the open flaps 260, as shown. When the baffle 270 is open, as shown, both of the deflector 250 and the flaps 260 are typically closed. In this case, the opening between the condenser portion 220b and fan 240 that is created by the open baffle 270 results in air through the LTR 210 being pulled through the fan 240.

FIG. 4 is a process flow of a method 400 of controlling covers of the package of vehicle heat exchanger modules with controlled covers (i.e., the CRFM package 110) according to one or more embodiments. Continuing reference is made to FIGS. 1-3. The processes discussed are performed by the controller 125 according to exemplary embodiments. At block 410, obtaining inputs indicating temperature and speed conditions may include obtaining power electronics loop and drive unit temperatures and the speed of the vehicle 100, as previously noted. Additional inputs may include the charging state of batteries 140, the status (e.g., on or off) of the air conditioner of the vehicle 100, and information about whether the vehicle 100 is pulling a trailer. At block 420, identifying a scenario based on the inputs includes identifying one of the exemplary scenarios indicated in Table 1, for example. At block 430, controlling the deflector 250, the flaps 260, and the baffle 270 based on the scenario is further discussed with reference to the examples set out in Table 1. The processes at blocks 420 and 430 may be implemented according to a rule-based mapping approach or via machine learning, for example.

TABLE 1
Exemplary flap control for exemplary scenarios.

| scenario | control of covers | effect |
|---|---|---|
| idle or direct current fast charging | deflector 250 | air flow is through |
| (DCFC) with air conditioning on or off | close | condenser portions alone |
| | flaps 260 | |
| | close | |
| | baffle 270 | |
| | close | |
| low vehicle speed | deflector 250 | most of the airflow is through |
| (e.g., 25 kilometers per hour (kph) range) | close | condenser portions and only |
| | flaps 260 | fan suction affects airflow |
| | close | through LTR |
| | baffle 270 | |
| | open | |
| medium speed (e.g., 50 kph range) | deflector 250 | increased air pressure at the |
| | close | front of the vehicle results |
| | flaps 260 | in airflow through the LTR |
| | open (50%) | and out through the flaps |
| | baffle 270 | |
| | close | |
| moderate speed (e.g., 90 kph range) | deflector 250 | even more air pressure at the |
| with trailer | open | front of the vehicle and a |
| (or incline or desert environment) | flaps 260 | vacuum created under the |
| high speed (e.g., 180 kph range) | open | vehicle by the open deflector |
| | baffle 270 | causes airflow through LTR |
| | close | directed out through the flaps |

Table 1 lists five exemplary scenarios that may be identified (at block 420) based on the inputs to the controller 125 from other vehicle system 130 (at block 410). The first scenario involves the vehicle 100 being idle, for example, or being stopped during direct current fast charging (DCFC). The cooling of the power electronics of the vehicle 100 via the LTR 210 is not relevant to the first scenario, and all the covers (deflector 250, flaps 260, baffle 270) are closed as shown in the FIG. 2 example. Thus, air flow is through the condenser portions 220 alone rather than additionally through the LTR 210. In the second scenario listed in Table 1, the speed of the vehicle 100 is low (e.g., below the 25 kilometers per hour (kph) range, for example). In this case, the baffle 270 is the only one of the covers that is opened by the controller 125. As FIG. 3 indicates, the baffle 270 being open facilitates airflow through the LTR 210 and out of the vehicle 100 via the fan 240. That is, most of the airflow is through the condenser portions 220 but the suction effect of the fan 240 facilitates some airflow through the LTR 210, as well.

The third scenario in Table 1 involves the speed of the vehicle 100 being a medium speed (e.g., greater than 25 kph, in the 50 kph range, for example). In this case, the flaps 260 are the only covers opened by the controller 125. At the increased speed of the vehicle 100, as compared with the first two scenarios in Table 1, there is increased air pressure through the air vents 115. This results in air flow through the LTR 210 and out of the vehicle 100 through the openings between the flaps 260, which are shown in FIG. 3. As indicated in Table 1, the flaps 260 may not be opened completely but, rather, may be opened partially (e.g., 50 percent (%)).

The fourth and fifth scenarios listed in Table 1 are treated similarly by the controller 125. According to the fourth scenario, the speed of the vehicle 100 is moderate (e.g., greater than 50 kph, in the 90 kph range, for example) and the vehicle 100 may be towing a trailer or traversing an incline or desert environment. That is, the vehicle 100 may be experiencing additional strain on the air conditioning and other systems. According to the fifth scenario, the speed of the vehicle 100 is high (e.g., greater than 90 kph, in the 180 kph range, for example). In both cases, the controller 125 opens both the deflector 250 and the flaps 260 but keeps the baffle 270 closed. The increased speed, as compared with the first three scenarios in Table 1, results in increased air pressure through the air vents 115. In addition, the open deflector 250 creates an air dam below the vehicle 100, as shown in FIG. 3. This causes an acceleration in air flow below the vehicle 100 and results in a vacuum under the vehicle 100 that increases air flow through the LTR 210 and out through the openings between the flaps 260. The flaps 260 may be open 100% based on the controller 125 identifying the scenario (at block 420) as being the fourth or fifth scenario.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system to dissipate heat in a vehicle, the system comprising:
a first condenser portion;
a second condenser portion arranged parallel with the first condenser portion;
a fan arranged parallel with the first condenser portion and the second condenser portion, the fan configured to draw air flow from the first condenser portion and the second condenser portion;
a radiator arranged substantially perpendicular with the first condenser portion and the second condenser portion;
one or more covers configured to be controlled to an open or closed position to affect dissipation of the heat from the first condenser portion, the second condenser portion, or the radiator; and
a controller configured to control the position of the one or more controlled covers.

2. The system according to claim 1, wherein the one or more covers include a deflector.

3. The system according to claim 2, wherein the deflector is configured to form an air dam below the vehicle in the open position.

4. The system according to claim 2, wherein the one or more covers include a set of flaps adjacent to the deflector.

5. The system according to claim 4, wherein the set of flaps is configured to facilitate air flow through the radiator and out of the vehicle in the open position.

6. The system according to claim 1, wherein the one or more covers include a baffle.

7. The system according to claim 6, wherein the baffle is configured to block one end of a gap between the fan and a closest one among the first condenser portion and the second condenser portion in the closed position.

8. The system according to claim 7, wherein the baffle is configured to facilitate air flow through the radiator to the fan via the one end of the gap in the open position.

9. The system according to claim 1, wherein the controller is configured to control the position of the one or more covers based on inputs.

10. The system according to claim 9, wherein the inputs include temperature, battery charging status, or a speed of the vehicle.

11. A method of configuring a heat dissipation system in a vehicle, the method comprising:
arranging a first condenser portion and a second condenser portion in parallel with each other;
disposing a fan in parallel with the first condenser portion and the second condenser portion, the fan being configured to draw air flow from the first condenser portion and the second condenser portion;
arranging a radiator to be substantially perpendicular with the first condenser portion and the second condenser portion;
arranging one or more covers configured to be controlled to an open or closed position to affect dissipation of the heat from the first condenser portion, the second condenser portion, or the radiator; and
configuring a controller to control the position of the one or more covers.

12. The method according to claim 11, wherein the arranging the one or more covers includes arranging a deflector at a perimeter of the vehicle.

13. The method according to claim 12, wherein controlling the deflector to be in the open position forms an air dam below the vehicle based on a location of the deflector at the perimeter of the vehicle.

14. The method according to claim 12, wherein the arranging the one or more covers includes arranging a set of flaps to be adjacent to the deflector at the perimeter of the vehicle.

15. The method according to claim 14, wherein controlling the set of flaps to be in the open position facilitates air flow through the radiator and out of the vehicle.

16. The method according to claim 14, wherein the configuring the controller to control the position of the one or more covers includes configuring the controller to control the set of flaps and the deflector to be in the open position together.

17. The method according to claim 11, wherein the arranging the one or more covers includes arranging a baffle to block one end of a gap between the fan and a closest one among the first condenser portion and the second condenser portion in the closed position.

18. The method according to claim 17, wherein controlling the baffle to be in the open position facilitates air flow through the radiator to the fan via the one end of the gap in an open position.

19. The method according to claim 11, further comprising the controller receiving inputs, wherein the inputs include temperature, battery charging status, or a speed of the vehicle.

20. The method according to claim 19, further comprising the controller identifying a scenario based on the inputs and controlling the position of the one or more covers according to the scenario.
